(19) United States
(12) Patent Application Publication
(10) Pub. No.: US 2026/0314638 A1
(43) Pub. Date: Oct. 15, 2026

(54) SHELF-STABLE BEVERAGE COMPOSITION

(71) Applicant: Jasmyn Turner, Tolleson, AZ (US)

(72) Inventor: Jasmyn Turner, Tolleson, AZ (US)

(21) Appl. No.: 19/567,778

(22) Filed: Mar. 16, 2026

Related U.S. Application Data
(60) Provisional application No. 63/788,527, filed on Apr. 14, 2025.

(51) Int. Cl. A23L 2/54; A23L 2/38; A23L 2/56; A23L 2/58; B65D 81/20; B65D 85/80

(52) U.S. Cl. CPC A23L 2/54; A23L 2/38; A23L 2/56; A23L 2/58; B65D 81/2053; B65D 85/80

(57) ABSTRACT

A shelf-stable beverage composition and related manufacturing method and production system. The beverage composition includes a base liquid (carbonated, non-carbonated, or nitro-infused), at least one flavoring syrup, a whitening agent, a stabilizer comprising at least one emulsifier, and a sealed container. The whitening agent may be dairy-based or plant-based, while the stabilizer may include emulsifiers such as sunflower lecithin, xanthan gum, or polysorbate 80. The manufacturing method includes preparing the base liquid, combining flavoring syrup with a whitening agent through emulsification, mixing components at chilled temperatures, adding stabilizers, and sealing in pressurized containers. The production system comprises a mixing apparatus, emulsification device, gas infusion mechanism for carbon dioxide and/or nitrogen, temperature-controlled blending chamber operating between 33 °F and 45 °F, and a filling station.

### CROSS REFERENCE TO RELATED APPLICATIONS

This application claims benefit from currently pending U.S. Provisional Application No. 63/788,527 titled “Shelf-Stable Beverage Composition” and having a filing date of Apr. 14, 2025, all of which is incorporated by reference herein.

### FIELD OF THE INVENTION

The present invention relates generally to beverage products and manufacturing processes, and more particularly to shelf-stable ready-to-drink (RTD) beverage formulations with mix in flavor characteristics.

### BACKGROUND OF THE INVENTION

In recent years, a specialty beverage category commonly referred to as “dirty beverages” or “dirty sodas” has gained significant popularity among consumers. These beverages typically combine a base beverage with flavored syrups, creams, fruits, and a whitening agent to create a distinctive visual appearance and flavor profile. The beverage category originated in specialty shops and has developed a substantial following, particularly in certain regional markets. The defining characteristics of these beverages include a partially mixed or “dirty” appearance, combined with unique flavor combinations and a creamy texture. The visual appeal stems from the partial integration of components, creating a marbled or layered appearance that is both aesthetically pleasing and indicative of the flavor experience.

Specialty beverage retailers have built business models around the manual preparation of these beverages. These shops employ trained staff who mix syrups, cream, and carbonated beverages to order at the point of sale. While successful in creating a specialty retail category, these operations fundamentally rely on manual preparation processes that prevent mass-market distribution and retail sale. Some beverage manufacturers have introduced flavored sodas that incorporate enhanced or specialty flavor profiles. These products attempt to capture elements of the specialty beverage trend but fail to replicate the distinctive visual and textural characteristics that define the category. These mass-produced beverages create homogeneous mixtures rather than achieving the desired partially-mixed state that gives “dirty beverages” their name and appeal.

Attempts to create shelf-stable dirty beverages have consistently encountered emulsification problems. The syrups and whitening agents naturally separate over time due to differences in density and molecular structure. Conventional emulsifiers have proven inadequate for maintaining the desired state of partial mixing while preventing complete separation. Temperature fluctuations during distribution and storage typically exacerbate these separation issues. Once separation occurs, both the visual appeal and flavor profile of the beverage are compromised. Conversely, attempts to force complete homogenization eliminate the distinctive marbled appearance that defines the category and creates its unique consumer appeal.

Prior art shelf-stable beverage compositions have addressed phase separation through the use of ultra-high-temperature (UHT) pasteurization and conventional homogenization processes. However, these processes fundamentally alter the organoleptic properties of the whitening agent, producing a cooked flavor, reducing the visual intensity of the marbled appearance, and limiting the range of whitening agents that can be employed. Additionally, prior art compositions have generally failed to achieve the specific aesthetic characteristic of the marbled dirty beverage format, specifically, the visible striations of the whitening agent suspended within the base liquid observable without agitation across a shelf life of six months or more

Preserving carbonation in RTD “dirty beverage” formulations presents challenges. The proteins found in whitening agents create nucleation sites that accelerate carbon dioxide release from solution. Traditional packaging solutions allow gradual gas escape over shelf life, resulting in a product that lacks the effervescence of freshly prepared versions. Manufacturers have attempted to address this by increasing pressure to compensate for anticipated CO₂ loss, but this approach often leads to uncontrolled foaming when the container is opened. Additionally, additives used to enhance carbonation retention typically impact flavor profiles negatively. The processing temperatures required for producing shelf-stable products often drive off dissolved gases, further complicating the challenge.

These significant technical limitations have created a substantial gap between the experience of consuming a freshly prepared “dirty beverage” and any shelf-stable alternative, preventing mass-market adoption and retail distribution of this popular beverage category. Therefore, there is a need for a shelf stable alternative to a freshly prepared “dirty beverage.”

### SUMMARY OF THE INVENTION

The present disclosure pertains to a shelf-stable beverage composition and methods of manufacturing the same. The beverage composition can include a base liquid, which can be a carbonated beverage, a non-carbonated beverage, or a nitro-infused beverage; at least one flavoring syrup; a whitening agent; a stabilizer comprising at least one emulsifier; and a sealed container. The whitening agent can be selected from dairy-based cream, milk, sweet cream, coconut cream, oat milk, almond milk, plant-based emulsions, and synthetic whitening agents. The flavoring syrup can be selected from coconut, vanilla, cherry, caramel, peach, mango, and combinations thereof. The stabilizer can include at least one emulsifier selected from sunflower lecithin, xanthan gum, and polysorbate 80. The sealed container can be a pressurized container such as an aluminum can or a PET bottle.

The base liquid can be a nitro-infused beverage comprising nitrogen gas and can further comprise carbon dioxide gas in combination with the nitrogen gas. Nitrogen may be included or omitted depending on the desired product characteristics. The beverage composition can have a shelf life of 6 to 12 months without separation of the whitening agent from the base liquid. The whitening agent can remain suspended in the carbonated base liquid without excessive foaming. The composition can maintain a visually marbled appearance and prevent complete separation of components for at least 6 months.

A method of manufacturing a shelf-stable beverage composition is also disclosed. The method can include preparing a base liquid, combining at least one flavoring syrup with a whitening agent using an emulsification process to form a flavored whitening mixture, mixing the flavored whitening mixture with the base liquid in a controlled environment at a chilled temperature, adding a stabilizer comprising at least one emulsifier, filling the beverage composition into a container, and sealing the container. The beverage composition maintains a visually marbled appearance without complete separation for at least 6 months.

The present disclosure further provides a system for producing a shelf-stable beverage. The system can include a mixing apparatus, an emulsification device, a gas infusion mechanism, a temperature-controlled blending chamber, and a filling station. The gas infusion mechanism can be configured to infuse the base liquid with at least one gas selected from carbon dioxide and nitrogen. The temperature-controlled blending chamber can maintain the mixture at a temperature between 33 °F and 45 °F during blending to preserve gas infusion and emulsion stability. The system can produce a beverage that maintains a visually marbled appearance without component separation for at least 6 months. The filling station can fill cans or bottles using counter-pressure filling, aseptic filling, or other suitable methods. Counter-pressure filling can prevent carbonation loss during canning and aseptic filling can maintain a sterile environment for still beverages.

Aspects and applications of the invention presented here are described below in the drawings and detailed description of the invention. Unless specifically noted, it is intended that the words and phrases in the specification and the claims be given their plain, ordinary, and accustomed meaning to those of ordinary skill in the applicable arts. The inventors are fully aware that they can be their own lexicographers if desired. The inventors expressly elect, as their own lexicographers, to use only the plain and ordinary meaning of terms in the specification and claims unless they clearly state otherwise and then further, expressly set forth the “special” definition of that term and explain how it differs from the plain and ordinary meaning. Absent such clear statements of intent to apply a “special” definition, it is the inventors'intent and desire that the simple, plain and ordinary meaning to the terms be applied to the interpretation of the specification and claims. Aspects and applications of the invention presented here are described below in the drawings and detailed description of the invention.

The inventors are also aware of the normal precepts of English grammar. Thus, if a noun, term, or phrase is intended to be further characterized, specified, or narrowed in some way, then such noun, term, or phrase will expressly include additional adjectives, descriptive terms, or other modifiers in accordance with the normal precepts of English grammar. Absent the use of such adjectives, descriptive terms, or modifiers, it is the intent that such nouns, terms, or phrases be given their plain, and ordinary English meaning to those skilled in the applicable arts as set forth above.

Further, the inventors are fully informed of the standards and application of the special provisions of 35 U.S.C. § 112 (f). Thus, the use of the words “function,” “means” or “step” in the Detailed Description or Description of the Drawings or claims is not intended to somehow indicate a desire to invoke the special provisions of 35 U.S.C. § 112 (f), to define the invention. To the contrary, if the provisions of 35 U.S.C. § 112 (f) are sought to be invoked to define the inventions, the claims will specifically and expressly state the exact phrases “means for” or “step for, and will also recite the word “function” (i.e., will state “means for performing the function of . . . ”), without also reciting in such phrases any structure, material or act in support of the function. Thus, even when the claims recite a “means for performing the function of . . . ” or “step for performing the function of . . . ,” if the claims also recite any structure, material or acts in support of that means or step, or that perform the recited function, then it is the clear intention of the inventors not to invoke the provisions of 35 U.S.C. § 112 (f). Moreover, even if the provisions of 35 U.S.C. § 112 (f) are invoked to define the claimed inventions, it is intended that the inventions not be limited only to the specific structure, material or acts that are described in the preferred embodiments, but in addition, include any and all structures, materials or acts that perform the claimed function as described in alternative embodiments or forms of the invention, or that are well known present or later-developed, equivalent structures, material or acts for performing the claimed function.

### BRIEF DESCRIPTION OF DRAWINGS

A more complete understanding of the present invention may be derived by referring to the detailed description when considered in connection with the following illustrative figures. In the figures, like reference numbers refer to like elements or acts throughout the figures.

FIG. 1 shows a flow chart of a shelf-stable beverage composition in accordance to one or more embodiments;

FIG. 2 shows a flow chart of a production system for a shelf-stable beverage composition in accordance to one or more embodiments;

FIG. 3 shows a flow chart of a method for manufacturing a shelf-stable beverage composition in accordance to one or more embodiments;

FIG. 4 shows a flow chart of a shelf-stable beverage composition in accordance to one or more embodiments; and

FIG. 5 shows a flow chart of a method for manufacturing a shelf-stable beverage composition in accordance to one or more embodiments.

Elements and acts in the figures are illustrated for simplicity and have not necessarily been rendered according to any particular sequence or embodiment.

### DETAILED DESCRIPTION OF THE INVENTION

In the following description, and for the purposes of explanation, numerous specific details are set forth to provide a thorough understanding of the various aspects of the invention. It will be understood, however, by those skilled in the relevant arts, that the present invention may be practiced without these specific details. In other instances, known structures and devices are shown or discussed more generally to avoid obscuring the invention. In many cases, a description of the operation is sufficient to enable one to implement the various forms of the invention, particularly when the operation is to be implemented in software. It should be noted that there are many different and alternative configurations, devices, and technologies to which the disclosed inventions may be applied. The full scope of the inventions is not limited to the examples that are described below.

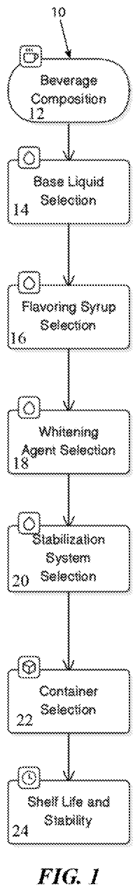

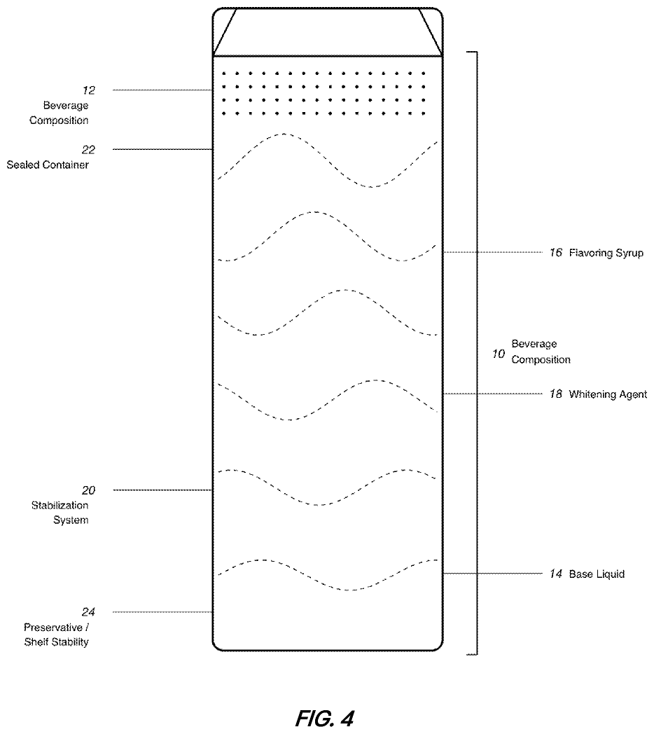

Referring to FIG. 1 and FIG. 4, a shelf-stable beverage composition is shown generally at 10. The beverage composition 12 can comprise a base liquid 14, at least one flavoring syrup 16, a whitening agent 18, a stabilizer 20, a preservative, and a sealed container 22. The base liquid provides structure to the beverage composition and can be a carbonated beverage, a non-carbonated beverage, or a nitro-infused beverage. The selection of the base liquid 14 can depend on the desired organoleptic properties of the final beverage product.

The beverage composition 12 can further comprise a sweetener system configured to provide a target sweetness intensity while maintaining compatibility with the other components. The sweetener system can comprise at least one sweetener selected from cane sugar, beet sugar, high-fructose corn syrup, glucose syrup, erythritol, sorbitol, xylitol, allulose, stevia leaf extract, rebaudioside A, rebaudioside M, monk fruit extract (luo han guo), sucralose, acesulfame potassium, aspartame, or combinations thereof. The sweetener system can be present in an amount effective to achieve a target sweetness level ranging from about 6° Brix to about 14° Brix sucrose equivalents as measured by refractometry. The sweetness target can be adjusted based on the flavor profile of the selected flavoring syrup 16 and the desired organoleptic characteristics of the final beverage composition 12.

Where a reduced-calorie or zero-calorie beverage composition 12 is desired, the sweetener system can comprise a blend of at least one high-intensity sweetener and at least one bulk sweetener. The high-intensity sweetener can provide primary sweetness perception and the bulk sweetener can contribute to mouthfeel and body characteristics that may be diminished in the absence of caloric sugars. The blend ratio can be selected to minimize off-notes commonly associated with individual high-intensity sweeteners, such as the bitter or metallic aftertaste associated with certain steviol glycosides or the cooling sensation associated with certain polyol sweeteners, through mutual flavor masking effects. The sweetener system can further comprise a sweetness modulator selected from thaumatin, brazzein, glycyrrhizin, or neohesperidin dihydrochalcone, in amounts ranging from about 1 ppm to about 50 ppm by weight of the total composition. The sweetness modulator can enhance the perceived sweetness intensity of the high-intensity sweetener blend and extend sweetness duration on the palate.

The osmolality of the beverage composition 12 can be influenced by the selection and concentration of the sweetener system. The sweetener system can be formulated in conjunction with the electrolyte system, where present, to achieve a target beverage osmolality of about 200 mOsm/kg to about 400 mOsm/kg, which can be compatible with gastric emptying rates that support timely delivery of the beverage's functional components. The sweetener system can also influence emulsion stability of the whitening agent 18 by modifying aqueous phase water activity and viscosity. The sweetener concentration can be selected in conjunction with the stabilizer 20 to maintain emulsion stability within target parameters throughout the designated shelf life.

The nitro-infused beverage can comprise nitrogen gas, or a combination of nitrogen gas and carbon dioxide gas. Nitrogen gas can be incorporated into the base liquid in an amount ranging from about 20 ppm to about 200 ppm. Alternatively, the nitro-infused beverage can comprise a combination of nitrogen gas and carbon dioxide gas at a ratio ranging from about 90:10 to about 10:90 by volume. Nitrogen gas can be incorporated using a gas infusion system comprising a pressurized vessel and a nitrogen source. The nitrogen source can be a compressed nitrogen gas cylinder, a nitrogen generator utilizing pressure swing adsorption technology, or a liquid nitrogen dewar with an appropriate vaporization system. The base liquid can be subjected to pressures ranging from about 30 psi to about 120 psi during the nitrogen infusion process.

The nitrogen-infused beverage can exhibit a cascading effect when dispensed, characterized by the formation and upward movement of nitrogen bubbles through the liquid. The cascading effect can persist for about 10 seconds to about 120 seconds after dispensing, depending on nitrogen concentration and the physical properties of the base liquid. When both nitrogen gas and carbon dioxide gas are used, the gases can be incorporated sequentially or simultaneously. Carbon dioxide gas can enhance the perceived effervescence while nitrogen gas provides a creamy mouthfeel and stable foam head. At nitrogen-to-carbon dioxide ratios of about 90:10 to about 10:90, the beverage can exhibit both cascading properties and traditional carbonation characteristics.

Dissolved nitrogen gas can range from about 20 ppm to about 200 ppm, or from about 35 ppm to about 150 ppm, or from about 50 ppm to about 100 ppm. At concentrations below about 20 ppm, the characteristic creamy mouthfeel and cascading effect may be insufficient for consumer perception. At concentrations above about 200 ppm, excessive foaming and package pressurization may occur, potentially compromising package integrity or consumer experience.

When carbon dioxide gas is incorporated in combination with nitrogen gas, dissolved carbon dioxide can range from about 500 ppm to about 4000 ppm depending on the desired level of carbonation. Lower carbon dioxide levels within this range can provide subtle effervescence, while higher levels can provide pronounced carbonation. The temperature during gas infusion significantly impacts gas solubility and retention. The infusion process can be conducted at temperatures ranging from about 1 °C to about 20 °C, with lower temperatures generally facilitating higher gas dissolution rates. Post-infusion, the beverage can be maintained at temperatures below about 10 °C to preserve dissolved gas content prior to packaging.

The nitro-infused beverage can further comprise a foam-stabilizing agent selected from propylene glycol alginate, quillaja extract, hydrolyzed proteins, modified starches, and combinations thereof. The foam-stabilizing agent can enhance the formation and stability of the creamy head produced by nitrogen infusion.

Foam performance can be evaluated by dispensing the beverage composition into a transparent cylindrical vessel or graduated cylinder having a total capacity of about 250 mL and an internal diameter of approximately 50-70 mm. The beverage may be conditioned to a temperature of about 4 °C to about 8 °C prior to testing. Dispensing may be performed at a controlled pour rate of approximately 80-120 mL per second, at a pour angle between about 45 degrees and about 90 degrees relative to horizontal, and from a dispensing height of approximately 2-5 cm above an interior surface of the container. The test may be performed at ambient pressure and room temperature conditions unless otherwise specified.

Immediately following dispensing, one or more foam characteristics may be measured, including: (i) Initial Foam Height (H₀), the vertical distance from the liquid-foam interface to the top of the foam column, measured within approximately 1-3 seconds after dispensing; (ii) Foam Volume Fraction (FVF), the ratio of foam volume to total dispensed volume, calculated as FVF=(foam volume/total dispensed volume)×100%, where foam volume is determined from graduations on the container; (iii) Foam Expansion Ratio (FER), the ratio of foam volume relative to liquid volume immediately after dispensing; and (iv) Foam Collapse Percentage (FCP), the percentage of foam converted to liquid after a defined evaluation period, measured at 30 seconds and/or 60 seconds following dispensing.

Excessive foaming may be determined when one or more of the following conditions are satisfied: (a) initial foam height greater than about 3 cm, optionally greater than about 4 cm; (b) foam volume fraction greater than about 25% to about 40% of the total dispensed beverage volume within 10 seconds after dispensing; (c) foam expansion ratio greater than about 0.33 to about 0.67; and/or (d) foam collapse percentage greater than about 50% within 30 seconds, indicating unstable or uncontrolled foam generation.

Acceptable foaming is characterized by foam formation below these thresholds, including a foam volume fraction of approximately 5% to 25% and a foam height less than about 3 cm, while maintaining desired sensory properties including visual appearance, carbonation expression, and mouthfeel.

The whitening agent 18 can be selected from dairy-based cream, milk, sweet cream, coconut cream, oat milk, almond milk, plant-based emulsions, synthetic whitening agents, and combinations thereof. The whitening agent 18 can remain suspended in the carbonated base liquid without excessive foaming and can maintain a visually marbled appearance, preventing complete separation of components for at least 6 months. The emulsification of the syrup and whitening agent mixture can use a high-shear mixer or homogenizer. The whitening agent 18 can also comprise ultrasonically homogenized plant protein complexes derived from combinations of pea protein, sunflower seed protein, pumpkin seed protein, or similar sources, wherein the protein complexes can be enzymatically modified to improve solubility and suspension characteristics in carbonated or nitro-infused environments. The whitening agent 18 can further comprise nano-emulsified plant oils treated with high-pressure homogenization at pressures exceeding 25,000 psi to create stable droplets below 100 nanometers in diameter, enhancing both stability and creaminess. The beverage composition can be stored in aluminum cans, clear containers, or other packaging formats. The whitening agent remains distributed without clumping or separation, preventing fragments or floating particles from pulling away from the mixture, while allowing the liquid to blend upon consumption without curdling or oil-and-water type phase separation.

The whitening agent 18 can incorporate calcium-complexed casein micelles that remain stable in acidic pH ranges from 3.2 to 6.8 without precipitation, overcoming traditional limitations of milk proteins in acidic beverages. The modified casein structures can be achieved through an ion-exchange process utilizing calcium, magnesium, potassium salts, or combinations thereof in specific ratios. The whitening agent 18 can also comprise hybrid emulsions combining both plant-based and synthetic components to create a multi-phase system with enhanced stability characteristics.

The stability test 46 can further comprise a foaming evaluation conducted at each sampling interval using the standardized dispensing and measurement method described herein. At each interval, sealed containers 22 can be conditioned to a temperature of about 4 °C to about 8 °C and dispensed into a transparent cylindrical vessel having a total capacity of about 250 mL and an internal diameter of approximately 50-70 mm at a controlled pour rate of approximately 80-120 mL per second from a height of approximately 2-5 cm. The acceptance criterion for foaming can require that the beverage composition exhibit a foam volume fraction of no greater than about 25% of total dispensed volume within 10 seconds after dispensing and an initial foam height (H₀) of no greater than about 3 cm as measured within approximately 1-3 seconds after dispensing. Batches exhibiting foam volume fractions or initial foam heights exceeding these thresholds can be considered to exhibit excessive foaming and can be rejected, with relevant formulation or process parameters adjusted prior to re-testing.

The flavoring syrup 16 can be selected from coconut, vanilla, cherry, caramel, peach, mango, and combinations thereof. The flavoring syrup 16 can further comprise botanical extracts selected from adaptogenic mushroom complexes, nootropic herb concentrates, blue spirulina extract, butterfly pea flower, functional fermented extracts, and similar ingredients. The botanical extracts can impart both flavor and functional benefits to the beverage composition. The flavoring syrup can incorporate time-released flavor encapsulation technology, wherein flavor compounds are encapsulated within modified starch or cyclodextrin matrices that dissolve at varying rates when consumed, providing a sequential flavor experience that evolves on the palate.

The flavoring syrup 16 can comprise polyphenol-rich fruit extracts derived from superfruits such as acerola cherry, elderberry, aronia berry, camu camu, maqui berry, or similar sources, wherein the extracts can be processed using a low-temperature extraction method that preserves heat-sensitive bioactive compounds and enhances bioavailability. The extraction process can utilize supercritical CO₂ technology operating at pressures between 7,000 and 10,000 psi and temperatures below 40 °C to selectively isolate desired flavor compounds while minimizing extraction of bitter principles.

The stabilizer 20 can prevent separation and can comprise at least one emulsifier selected from sunflower lecithin, xanthan gum, polysorbate 80, and combinations thereof. The sunflower lecithin can be present at 0.1 oz to 1 oz, xanthan gum at 0.05 oz to 1 oz, and polysorbate 80 at 0.01 oz to 1 oz. The stabilizer 20 can maintain the physical integrity and homogeneity of the beverage composition by preventing phase separation between the base liquid and other components such as whitening agents and flavor oils. The stabilizer 20 can reduce interfacial tension between immiscible phases, create energy barriers to coalescence, and form three-dimensional networks that impede particle movement within the liquid. In carbonated or nitro-infused embodiments, the stabilizer can control gas release kinetics, thereby promoting proper bubble formation and mouthfeel characteristics. The stabilizer 20 can further contribute to organoleptic properties by influencing texture, viscosity, and overall sensory experience while extending product shelf life through maintenance of consistent appearance and flavor profile throughout storage.

The sealed container 22 can be a pressurized container such as an aluminum can, a PET bottle, a glass bottle, a polyethylene terephthalate plastic bottle, a high-density polyethylene plastic bottle, or similar packaging. The sealed container can withstand internal pressures ranging from about 10 psi to about 70 psi, thereby accommodating various levels of carbonation and nitrogen infusion. The sealed container 22 can incorporate a multi-layer barrier system designed to minimize gas permeation while maintaining product integrity throughout the designated shelf life.

The sealed container 22 can comprise an active packaging system with integrated oxygen-scavenging nanocomposites embedded within the container structure. The nanocomposites can comprise iron-based nanoparticles dispersed within a food-grade polymer matrix at concentrations between 0.5% and 3.0% by weight. The nanoparticles can be surface-modified with citric acid derivatives to enhance oxygen-scavenging capacity while preventing migration into the beverage. The active packaging system can reduce oxygen transmission rates to below 0.001 cc/package/day, thereby extending product shelf life by minimizing oxidative degradation of sensitive flavor compounds and whitening agents.

The sealed container 22 can have a pressure regulation system comprising a microporous membrane element with asymmetric pore structure. The membrane can permit selective transmission of carbon dioxide while restricting passage of nitrogen and oxygen, thereby maintaining optimal gas ratios within the container throughout shelf life. The membrane element can have an average pore diameter gradient ranging from 100 nanometers at the internal surface to 20 nanometers at the external surface, creating directional gas permeation characteristics. The sealed container can also have an interior coating comprising amorphous carbon film applied through plasma-enhanced chemical vapor deposition, with a thickness between 10 and 50 nanometers. The coating can provide an effective barrier against gas permeation while eliminating potential interactions between beverage components and container material. The carbon film can be deposited at temperatures below 60 °C, thereby preserving the structural integrity of temperature-sensitive container materials such as PET.

The shelf-stable beverage composition can further comprise a preservative that allows for shelf life and stability 24. The preservative can comprise at least one of sodium benzoate, citric acid, ascorbic acid, or similar compounds. The preservative can be present in an amount effective to inhibit microbial growth and prevent oxidative degradation of beverage components, thereby extending shelf life under ambient storage conditions. The preservative can be present in amounts ranging from about 0.01% to about 0.5% by weight of the total composition.

The preservative can comprise a synergistic antimicrobial system wherein combinations of preservative compounds exhibit enhanced efficacy compared to individual components alone. The system can include combinations of organic acids and their salts, wherein the undissociated acid forms predominate at the beverage pH, facilitating enhanced penetration across microbial cell membranes. The antimicrobial system can exhibit minimum inhibitory concentrations (MIC) against common beverage spoilage organisms that are 40% to 70% lower than the MICs of individual components.

The preservative can further comprise a multi-barrier antimicrobial delivery system wherein preservative compounds are encapsulated within pH-responsive polymer microspheres having a wall thickness ranging from about 0.5 micrometers to about 5 micrometers. The microspheres can be formed from cellulose acetate phthalate, hydroxypropyl methylcellulose phthalate, or similar polymers, wherein the polymer wall dissolves at pH values below about 4.5, releasing preservative compounds directly within the acidic microenvironment of the beverage. The microsphere diameter can range from about 10 micrometers to about 200 micrometers, or from about 25 micrometers to about 100 micrometers. Microspheres within the narrower range can remain suspended within the beverage matrix without visible settling over a storage period of at least 12 months at ambient temperatures between about 15 °C and about 30 °C Encapsulation efficiency of the preservative compounds within the microspheres can range from about 70% to about 99%, as measured by high-performance liquid chromatography (HPLC) extraction and analysis.

The shelf-stable beverage composition can further comprise a functional ingredient delivery system comprising a dual-layered microcapsule structure. An inner core can contain water-soluble bioactive compounds and an outer shell can contain lipid-soluble bioactive compounds. The inner core can comprise B-complex vitamins, electrolytes, amino acids, adaptogenic compounds, or combinations thereof. The inner core can be formed by spray drying at inlet temperatures between about 150 °C and about 200 °C and outlet temperatures between about 60 °C and about 90 °C to produce a vitrified amorphous matrix that protects bioactive compounds from degradation during storage. The outer shell can comprise medium-chain triglycerides, beeswax, carnauba wax, hydrogenated vegetable oils, or combinations thereof applied by fluid bed coating at temperatures between about 30 °C and about 50 °C to create a continuous lipid barrier having a thickness ranging from about 2 micrometers to about 20 micrometers. The dual-layered microcapsule can release both inner core and outer shell contents within about 30 seconds to about 5 minutes of oral consumption, triggered by mechanical chewing action combined with salivary amylase activity and oral temperature of approximately 37 °C.

The sealed container 22 can further comprise an integrated insert comprising a hollow sealed body having an internal cavity containing pressurized nitrogen gas at pressures ranging from about 25 psi to about 60 psi. The insert can be fabricated from food-grade materials such as high-density polyethylene, polypropylene, acrylonitrile butadiene styrene, or combinations thereof, and can have an overall diameter ranging from about 20 mm to about 40 mm and a height ranging from about 10 mm to about 30 mm. The insert can comprise at least one orifice having a diameter ranging from about 0.1 mm to about 1.0 mm through which the pressurized nitrogen can be expelled upon container opening, creating a cascading surge of nitrogen microbubbles having diameters ranging from about 10 micrometers to about 100 micrometers throughout the beverage. The insert can comprise a plurality of orifices arranged in a radially symmetric pattern, numbering between about 3 and about 12 orifices spaced at equal angular intervals, producing a uniform radial distribution of nitrogen microbubbles that enhances the consistency and visual quality of the cascading effect. The insert can be secured within the sealed container by at least one retention element selected from snap-fit engagement features, adhesive bonding, ultrasonic welding, interference fit, or similar configurations.

The flavoring syrup 16 can further comprise a sequential flavor release architecture wherein flavor compounds are partitioned into at least three distinct delivery matrices characterized by differential release kinetics. A first delivery matrix can comprise free-form water-soluble flavor compounds that release instantaneously upon oral contact, providing an initial flavor burst. A second delivery matrix can comprise flavor compounds encapsulated within cyclodextrin complexes. The cyclodextrin can be selected from alpha-cyclodextrin, beta-cyclodextrin, gamma-cyclodextrin, hydroxypropyl-beta-cyclodextrin, or combinations thereof. The cyclodextrin complexes can release encapsulated flavor compounds over about 30 seconds to about 3 minutes in response to salivary dilution and competitive displacement by oral cavity compounds. A third delivery matrix can comprise flavor compounds encapsulated within lipid-based nanoparticles having a mean particle diameter ranging from about 50 nanometers to about 500 nanometers as measured by dynamic light scattering. The nanoparticles can provide sustained flavor release over about 3 minutes to about 15 minutes following consumption. The partitioning ratio of flavor compounds among the first, second, and third delivery matrices can range from about 10:60:30 to about 40:40:20 by weight. The combined sequential release profile can extend total flavor perception duration by a factor of about 3 to about 10 compared to an equivalent composition comprising only free-form flavor compounds.

The flavoring syrup 16 can be formulated to achieve a target viscosity compatible with the formation and maintenance of visible striations within the beverage composition 12. The viscosity of the flavoring syrup 16 can range from about 50 centipoise (cP) to about 2,000 cP as measured at 25 °C using a rotational viscometer at a shear rate of 10 s⁻¹. The viscosity of the whitening agent 18 can similarly range from about 40 cP to about 1,800 cP under equivalent measurement conditions, such that the viscosity ratio of the flavoring syrup 16 to the whitening agent 18 ranges from about 0.5:1 to about 3:1. When the viscosity ratio falls within this range, the interface between the flavoring syrup 16 and the whitening agent 18 can exhibit sufficient resistance to convective mixing to maintain visually distinct striations within the beverage composition 12 throughout the designated shelf life without complete integration of the two phases.

The viscosity of the flavoring syrup 16 can be adjusted through modification of dissolved solids content, selection of hydrocolloid thickeners, or temperature-controlled processing. The dissolved solids content of the flavoring syrup 16 can range from about 55° Brix to about 75° Brix as measured by refractometry, wherein higher dissolved solids concentrations correspond to increased syrup viscosity. Hydrocolloid thickeners selected from locust bean gum, guar gum, gellan gum, carrageenan, pectin, and combinations thereof can be incorporated into the flavoring syrup 16 in amounts ranging from about 0.05% to about 0.5% by weight of the flavoring syrup to achieve the target viscosity independent of dissolved solids content. The viscosity of the flavoring syrup 16 and whitening agent 18 can be verified by inline viscometry during the emulsification process 38. Batches exhibiting viscosity values outside the specified ranges can be adjusted by adding supplemental dissolved solids or hydrocolloid components prior to advancing to the blending step 40.

The whitening agent 18 can further comprise a self-assembling protein-lipid nanostructure wherein food-grade proteins are combined with specific lipid fractions to form organized lamellar structures having repeat spacing distances ranging from about 4 nanometers to about 20 nanometers as detectable by small-angle X-ray scattering (SAXS). The proteins can be selected from whey protein isolate, pea protein isolate, soy protein isolate, rice protein concentrate, or combinations thereof, present in an amount ranging from about 0.5% to about 5.0% by weight of the whitening agent. The lipid fraction can be selected from monoglycerides, diglycerides, phosphatidylcholine, phosphatidylethanolamine, or combinations thereof, present in an amount ranging from about 0.1% to about 3.0% by weight of the whitening agent. The self-assembling nanostructures can be formed by subjecting a combined protein-lipid mixture to heat treatment at temperatures ranging from about 70 °C to about 95 °C for about 5 minutes to about 30 minutes, followed by rapid cooling to below about 10 °C at a cooling rate of at least about 5 °C per minute. The heat-cool cycle can promote irreversible protein conformational changes that expose hydrophobic regions capable of associating with the lipid fraction to form lamellar nanostructures. The resulting nanostructures can maintain a colloidal particle size of less than about 200 nanometers for a storage period of at least about 12 months at temperatures ranging from about 4 °C to about 30 °C, as measured by dynamic light scattering.

The shelf-stable beverage composition can further comprise a carbonation retention enhancement system wherein the base liquid is treated with at least one surface-active polysaccharide prior to carbonation to physically modify the gas-liquid interface. The surface-active polysaccharide can be selected from Arabic gum, fenugreek gum, saponin-rich yucca extract, quillaja saponin extract, or similar compounds, present in an amount ranging from about 0.01% to about 1.0% by weight of the total composition. The surface-active polysaccharide can adsorb at the gas-liquid interface within the beverage to form a viscoelastic interfacial film having an interfacial elastic modulus ranging from about 1 mN/m to about 100 mN/m as measured by pendant drop tensiometry with oscillatory deformation. The viscoelastic interfacial film can reduce carbon dioxide loss rates by about 20% to about 60% compared to a control beverage lacking the surface-active polysaccharide treatment, thereby extending effective carbonation shelf life and maintaining consumer-perceptible effervescence. The carbonation retention enhancement system can further comprise a secondary treatment wherein the sealed container 22 is subjected to ultrasonic irradiation at frequencies ranging from about 20 kHz to about 100 kHz and power densities ranging from about 1 W/cm² to about 50 W/cm² for about 1 second to about 30 seconds following filling and sealing. The ultrasonic treatment can homogenize dissolved gas distribution throughout the beverage to reduce localized supersaturation zones that might otherwise promote premature nucleation and gas loss.

The shelf-stable beverage composition can further comprise a pH-buffering system comprising at least one buffering pair selected to maintain beverage pH within a target range of about 3.0 to about 5.5 throughout the designated shelf life. The buffering pair can be selected from citric acid and sodium citrate, phosphoric acid and monosodium phosphate, malic acid and sodium malate, tartaric acid and sodium tartrate, lactic acid and sodium lactate, or combinations thereof. Total buffering capacity can range from about 5 mEq/L to about 50 mEq/L at the target pH, wherein buffering capacity is defined as the millimoles of strong acid or base required to shift 1 liter of the beverage by 1 pH unit. The pH-buffering system can stabilize acid-sensitive flavor compounds, preserve whitening agent colloidal stability, and maintain antimicrobial preservative efficacy by keeping at least about 50% of the preservative compound in its un-ionized, antimicrobially active form throughout shelf life. The buffering pair can be combined with a pH-indicator dye encapsulated within the sealed container 22 at a location external to the beverage product, such as within a label layer or printed indicator strip. The pH-indicator dye can produce a visually perceptible color change to indicate when the beverage pH has shifted outside the target range due to container compromise, temperature abuse, or shelf life exceedance.

The sealed container 22 can further comprise a tamper-evident freshness indicator comprising a time-temperature integrator (TTI) element affixed to an exterior surface. The TTI element can comprise a diffusion-based system wherein a colored dye formulation migrates through a porous polymeric membrane having a controlled tortuosity factor ranging from about 2 to about 10. The diffusion rate of the colored dye can follow Arrhenius kinetics with an activation energy ranging from about 50 kJ/mol to about 120 kJ/mol. The TTI element can be calibrated to a specific shelf-life endpoint corresponding to a predetermined combination of time and temperature exposure. Color development in the TTI can progress from a first color state having a Commission Internationale de l'Éclairage (CIE) L*value above about 80 for a fresh product to a second color state having a CIE L*value below about 40 for an expired product, providing a visually unambiguous end-of-life indication. The TTI element can be integrated into a printed label comprising a radio-frequency identification (RFID) tag capable of storing and transmitting time-temperature history data wirelessly to a compatible reader device. The RFID tag can comprise a temperature-sensitive resistor element having a resistance that changes monotonically with temperature at a rate ranging from about 0.1%/°C to about 5%/°C, enabling electronic logging of cumulative thermal exposure throughout the distribution chain.

The shelf-stable beverage composition can further comprise an electrolyte system comprising at least two electrolyte compounds selected to provide synergistic hydration characteristics. The electrolyte compounds can be selected from sodium chloride, potassium chloride, magnesium chloride, calcium lactate, sodium phosphate, potassium bicarbonate, magnesium lactate, or combinations thereof. The electrolyte system can provide total electrolyte content ranging from about 50 mg/serving to about 1,000 mg/serving, wherein the molar ratio of sodium to potassium ranges from about 1:1 to about 1:4, reflecting the approximate intracellular-to-extracellular electrolyte gradient of human tissue.

The electrolyte compounds can be combined with at least one co-solvent selected from sorbitol, mannitol, erythritol, glycerol, or combinations thereof. The co-solvent can be present in an amount ranging from about 0.1% to about 5.0% by weight of the total composition and can function to reduce osmolality of the electrolyte solution to a target range of about 200 mOsm/kg to about 330 mOsm/kg. This target osmolality can facilitate transepithelial water transport in the small intestine at rates about 20% to about 40% higher than water alone, as measured by in vitro intestinal epithelial membrane flux assays. The electrolyte system can further comprise an organic acid chelator selected from gluconate, citrate, malate, or combinations thereof. The chelator can maintain divalent cation electrolytes in soluble form throughout the beverage pH range by forming coordination complexes having stability constants ranging from about log K=1 to about log K=5.

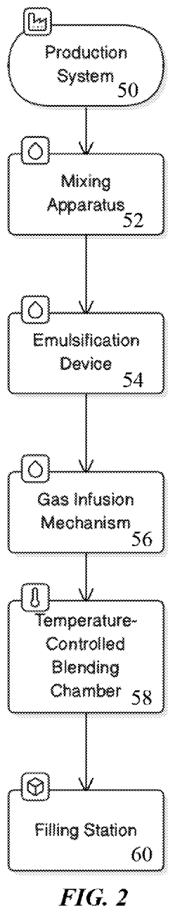

Referring to FIG. 2, the shelf-stable beverage composition can be manufactured using a continuous in-line production process comprising physically distinct processing stages. A first processing stage can comprise high-shear mixing of the whitening agent and stabilizer components in a rotor-stator mixer operating at a tip speed ranging from about 10 m/s to about 40 m/s for a residence time of about 30 seconds to about 5 minutes. A second processing stage can comprise ultra-high temperature (UHT) treatment of the mixed composition at temperatures ranging from about 135 °C to about 145 °C for a hold time of about 2 seconds to about 15 seconds using an indirect heat exchanger, followed by aseptic cooling to below about 25 °C within about 30 seconds to about 120 seconds.

A third processing stage can comprise inline carbonation and/or nitrogen infusion using a carbonation block comprising a plurality of parallel hollow fiber membranes having a membrane wall thickness ranging from about 50 micrometers to about 500 micrometers. Gas can be dissolved into the liquid phase under pressures ranging from about 30 psi to about 150 psi at temperatures ranging from about 1 °C to about 10 °C A fourth processing stage can comprise aseptic filling of the processed composition into pre-sterilized sealed containers under a positive pressure nitrogen blanket to prevent oxygen ingress. The filling line can operate at a throughput rate ranging from about 100 containers per minute to about 2,000 containers per minute. The continuous in-line production process can achieve a total product residence time from mixing to sealed container of less than about 30 minutes, thereby minimizing the window for microbial contamination, oxidative degradation, and flavor loss compared to batch production processes having typical residence times exceeding about 4 hours.

The production system 50 can comprise a mixing apparatus 52, an emulsification device 54, a gas infusion mechanism 56, a temperature-controlled blending chamber 58, and a filling station 60. The mixing apparatus 52 can comprise stainless steel tanks with variable-speed agitators that facilitate homogeneous blending of liquid and dry ingredients, equipped with precision metering pumps for accurate ingredient dosing and temperature monitoring probes to maintain optimal mixing conditions. The emulsification device 54 can comprise a high-pressure homogenizer capable of operating at pressures up to 10,000 psi, creating stable micro-emulsions of flavoring oils and other immiscible components by reducing droplet size to below 1 micron for improved stability and mouthfeel. The gas infusion mechanism 56 can infuse the base liquid with at least one gas selected from carbon dioxide and nitrogen. The gas infusion mechanism 56 can have a carbonation system with controlled gas-to-liquid ratios, capable of infusing multiple gases (CO₂, N₂, O₂) in predetermined combinations through pressure-regulated dissolution chambers for consistent gas solubility.

Stabilizers and preservatives are slowly incorporated into the blend. The base liquid is combined with the emulsified blend at temperatures between about 32 °C and about 35 °C. The temperature-controlled blending chamber 58 combines the stable emulsion with the gas-infused base liquid, and the filling station packages the combined mixture into sealed containers. The temperature-controlled blending chamber 58 can comprise a double-jacketed vessel with glycol cooling/heating capability that maintains precise temperature control within ±0.5 °C throughout processing, featuring vacuum capability to remove dissolved oxygen prior to packaging and gentle agitation systems to preserve carbonation levels. The filling station 60 can comprise a counter-pressure filling system to preserve carbonation integrity, capable of handling multiple container formats (PET, glass, aluminum) with inert gas flushing to minimize oxygen in headspace, incorporating precision fill-level sensors for consistent product volume and high-speed capping/sealing mechanisms. The system produces a beverage that maintains a visually marbled appearance without component separation for at least 6 months. The gas infusion mechanism 56 can infuse the base liquid with a combination of carbon dioxide and nitrogen in variable ratios. The temperature-controlled blending chamber 58 maintains the mixture at a temperature between 33 °C and 45 °C during blending to preserve gas infusion and emulsion stability.

The production system 50 can further comprise an integrated nitrogen insert assembly station positioned between the filling station 60 and a seaming station. The insert assembly station can place a hollow sealed body within the sealed container 22 prior to or during the filling operation. The hollow sealed body can contain pressurized nitrogen gas at pressures ranging from about 25 psi to about 60 psi and can be fabricated from food-grade materials such as high-density polyethylene, polypropylene, acrylonitrile butadiene styrene, or combinations thereof. The hollow sealed body can comprise at least one orifice having a diameter ranging from about 0.1 mm to about 1.0 mm through which pressurized nitrogen is expelled upon opening of the sealed container 22. Upon opening, the expelled nitrogen creates a surge of nitrogen microbubbles having diameters ranging from about 10 micrometers to about 100 micrometers throughout the beverage composition 12, producing a cascading visual effect that enhances the visually marbled appearance of the whitening agent 18 within the base liquid 14 at the point of consumption. The insert assembly station can secure the hollow sealed body within the sealed container 22 using at least one retention element selected from snap-fit engagement features, adhesive bonding, ultrasonic welding, or interference fit configurations, and can operate at throughput rates compatible with high-speed filling lines ranging from about 100 containers per minute to about 2,000 containers per minute.

The beverage composition 12 can deliver a distinctive and reproducible consumer experience upon opening and dispensing. When the sealed container 22 is opened, the pressure differential between the container interior and the ambient environment causes pressurized nitrogen within the integrated insert, where present, to be expelled through the orifice or plurality of orifices into the beverage composition 12. This generates a surge of nitrogen microbubbles having diameters ranging from about 10 micrometers to about 100 micrometers. The microbubble surge produces a cascading visual effect characterized by upward movement of the microbubbles through the beverage composition 12, disrupting the settled or stratified configuration of the whitening agent 18 and redistributing it throughout the base liquid 14 in a marbled pattern. The cascading effect can persist for about 15 seconds to about 90 seconds following container opening, depending on nitrogen concentration, beverage temperature, and container dimensions.

Upon dispensing the beverage composition 12 into a serving vessel, the whitening agent 18 distributes throughout the base liquid 14 in a partially integrated manner, producing visible striations or swirls of the whitening agent 18 against the colored or clear base liquid 14, perceptible to the consumer without mechanical agitation. The partial distribution of the whitening agent 18 can be influenced by pour angle, pour rate, and serving vessel geometry, producing visual patterns consistent with the aesthetic characteristics of freshly prepared specialty “dirty beverages.” The consumer can optionally agitate the serving vessel gently after dispensing to further distribute the whitening agent 18 and flavoring syrup 16 to a desired degree of integration, providing a customizable flavor and visual experience. The mouthfeel upon consumption can be characterized by an initial effervescence from dissolved carbon dioxide, followed by a creamy texture contributed by the whitening agent 18 and any dissolved nitrogen, with a sequential flavor progression provided by the multi-matrix flavoring system of the flavoring syrup 16 where present.

The temperature-controlled blending chamber 58 can further comprise a vacuum de-aeration subsystem configured to remove dissolved oxygen from the beverage composition 12 prior to gas infusion by the gas infusion mechanism 56. The vacuum de-aeration subsystem can reduce dissolved oxygen content to below about 0.5 parts per million prior to carbonation or nitrogen infusion, minimizing oxidative degradation of flavor compounds in the flavoring syrup 16 and lipid components of the whitening agent 18 during storage. The vacuum de-aeration subsystem can operate at absolute pressures ranging from about 10 mbar to about 100 mbar and can be integrated with the double-jacketed glycol cooling system of the temperature-controlled blending chamber 58 so that de-aeration and chilling occur simultaneously in a single processing vessel, reducing overall system footprint and total product residence time. Following de-aeration, the headspace of the temperature-controlled blending chamber 58 can be purged with nitrogen gas to maintain a positive inert gas blanket over the beverage composition 12 throughout blending and transfer operations, preventing oxygen re-dissolution prior to filling.

The production system 50 can further comprise an inline dissolved gas concentration sensor array positioned between the gas infusion mechanism 56 and the temperature-controlled blending chamber 58, and a second inline dissolved gas concentration sensor array positioned at the output of the filling station 60. Each sensor array can comprise at least one membrane-based infrared dissolved gas analyzer configured to measure dissolved nitrogen concentration and dissolved carbon dioxide concentration simultaneously in real time without interrupting product flow. The sensor arrays can be operatively connected to a process controller configured to receive concentration measurements and automatically adjust gas flow rates at the gas infusion mechanism 56 via mass flow controllers to maintain target dissolved gas concentrations within a tolerance of ±5% of setpoint values throughout a production run. The process controller can independently vary the flow rates of nitrogen and carbon dioxide in response to real-time sensor feedback, enabling dynamic adjustment of the nitrogen-to-carbon dioxide ratio to compensate for temperature fluctuations, base liquid viscosity variations, and other process disturbances that may affect gas solubility during continuous production. This closed-loop dissolved gas control system can reduce batch-to-batch variation in dissolved gas content to below about 3% relative standard deviation, providing consistent mouthfeel, cascading effect, and carbonation characteristics across the shelf life of the beverage composition 12.

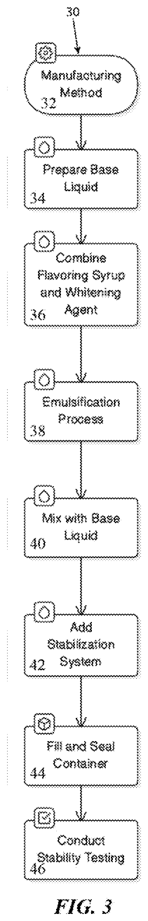

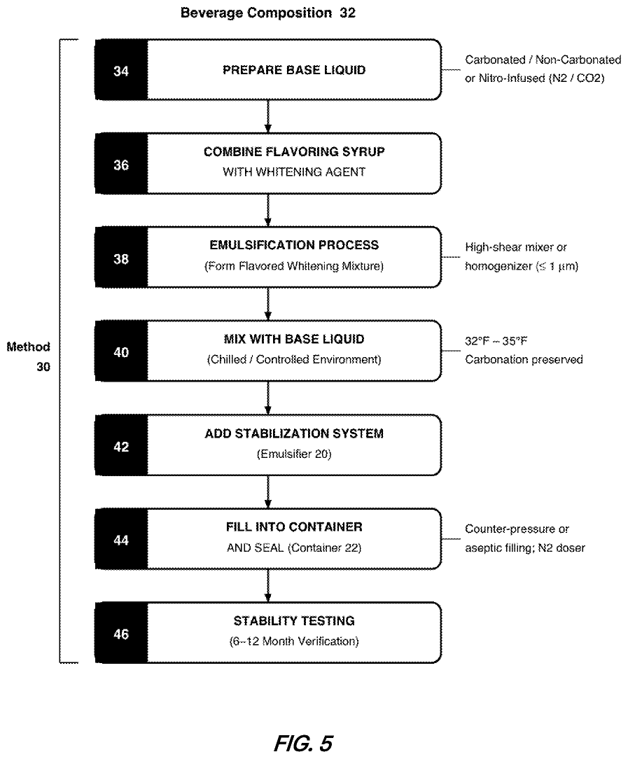

Referring to FIG. 3 and FIG. 5, a method of manufacturing 30 the beverage composition 32 comprises preparing the base liquid 34, combining at least one flavoring syrup with a whitening agent 36 using an emulsification process 38 to form a flavored whitening mixture, and mixing the flavored whitening mixture with the base liquid 40 in a controlled environment at a chilled temperature. The mixing apparatus can perform high-shear mixing or high-pressure homogenization for emulsification, followed by carbonation. The mixing apparatus can combine a whitening agent with at least one flavoring syrup, and the emulsification device creates a stable emulsion of the whitening agent and the flavoring syrup. The stabilizer 42 is then added, and the beverage composition is filled into a container. Nitrogen is applied by a liquid nitrogen doser when needed, and the container is sealed 44. The beverage composition maintains a visually marbled appearance without complete separation for at least 6 months. A stability test 46 is then conducted on the container.

The stability test 46 can comprise an accelerated shelf-life testing protocol conducted under controlled environmental conditions designed to predict product stability over the designated shelf life of 6 to 12 months within a compressed testing timeframe. The accelerated protocol can expose sealed containers 22 of the beverage composition 12 to elevated temperature and humidity conditions in accordance with established accelerated aging methodologies.

The stability test 46 can comprise periodic sampling of sealed containers 22 at predetermined time intervals, including at least at 0, 30, 60, and 90 days under the accelerated conditions. At each sampling interval, the following parameters can be measured and compared against predetermined acceptance criteria: (a) dissolved carbon dioxide concentration, measured by a pressure-based method and expressed as volumes of CO₂ per volume of beverage, with an acceptance criterion requiring retention of at least about 80% of the initial dissolved carbon dioxide concentration; (b) dissolved nitrogen concentration, measured by membrane-based infrared analysis, with an acceptance criterion requiring retention of at least about 85% of the initial dissolved nitrogen concentration; (c) beverage pH, measured by calibrated potentiometric electrode, with an acceptance criterion requiring maintenance of target pH within a tolerance of ±0.3 pH units from the initial value; (d) mean emulsion droplet diameter D(4,3) of the whitening agent 18, measured by laser diffraction particle size analysis, with an acceptance criterion requiring that mean droplet diameter does not exceed about 2.0 micrometers; (e) visual marbling assessment, conducted by standardized photographic documentation and colorimetric image analysis under controlled lighting conditions; and (f) microbiological enumeration of total aerobic plate count, yeast, and mold, with acceptance criteria requiring counts below applicable regulatory limits throughout the testing period. Batches failing any acceptance criterion at any sampling interval can be rejected, with relevant formulation or process parameters adjusted prior to re-testing.

The stability test 46 can further comprise a real-time stability arm conducted in parallel with the accelerated protocol, wherein duplicate sealed containers 22 are stored at ambient conditions of about 25 °C and about 60% relative humidity and sampled at intervals of 0, 1, 3, 6, 9, and 12 months for measurement of the same parameters, providing confirmatory real-time stability data to support the accelerated testing predictions over the product's commercial shelf life.

One example formulation relates to a carbonated dirty soda beverage. The carbonated dirty soda comprises approximately 85% by weight of a carbonated soda base, approximately 7% by weight of a sugar or sweetener component, approximately 3% by weight of a flavor syrup, approximately 2% by weight of a whitening agent, approximately 2% by weight of a stabilizer blend, and approximately 1% by weight of a preservative. The stabilizer blend may comprise approximately 0.2 ounces of lecithin, approximately 0.1 ounces of xanthan gum, and optionally approximately 0.05 ounces of polysorbate 80. The method of preparation comprises pre-carbonating the soda base at approximately 35 to 50 PSI using carbon dioxide injection; mixing the syrup, sweeteners, and whitening agent using a high-shear mixer; slowly incorporating the stabilizers while continuously mixing; blending the carbonated base into the stabilized syrup and cream mixture at approximately 35 °C or below; filling containers such as cans or bottles using a counter-pressure filler; sealing the containers; and conducting carbonation integrity tests. This formulation and method are suitable for producing carbonated dirty soda beverages in various container sizes, including but not limited to 12-ounce and 20-ounce containers.

The method of manufacturing 30 can further comprise a pH adjustment step performed between the emulsification process 38 and the addition of the stabilizer 42. A pH-adjusting agent can be introduced into the flavored whitening mixture to establish a target beverage pH of between about 3.0 and about 5.5 prior to blending with the base liquid 14. The pH-adjusting agent can be selected from citric acid, phosphoric acid, malic acid, sodium citrate, potassium citrate, or combinations thereof, and can be introduced in metered quantities controlled by an inline pH sensor and an automated dosing pump to maintain target pH within a tolerance of ±0.1 pH units throughout the blending operation. Establishing the target pH prior to incorporation of the stabilizer 42 can maximize emulsifier adsorption at the fat globule interface during the subsequent blending step 40, because the emulsification efficiency of phospholipid-based emulsifiers such as sunflower lecithin is pH-dependent. Pre-adjustment of pH to the target range can produce a more stable emulsion than is achieved when pH adjustment is performed after emulsifier addition.

The pH adjustment step can further comprise the addition of a pH-buffering pair such as citric acid and sodium citrate in a molar ratio selected to provide a buffering capacity of between about 5 mEq/L and about 50 mEq/L at the target pH. The buffering capacity can maintain beverage pH stability throughout a shelf life of at least 6 months at ambient storage conditions, preserving both antimicrobial efficacy of any preservative component and colloidal stability of the whitening agent 18 against protein precipitation or fat globule coalescence that can occur at pH values outside the target range.

The pH-buffering system can be specifically formulated with respect to the isoelectric point (pI) of the protein components present in the whitening agent 18. Dairy-derived whitening agents, such as cream or milk, comprise casein proteins having an isoelectric point of approximately pH 4.6, at which the net surface charge of casein micelles approaches zero and electrostatic repulsion between protein particles is minimized, resulting in maximum propensity for protein aggregation, precipitation, and visible curdling. Plant-based whitening agents comprising pea protein isolate, oat protein, or soy protein isolate similarly exhibit isoelectric points ranging from about pH 4.2 to about pH 5.0 depending on source and degree of processing.

To maintain adequate colloidal stability of the whitening agent 18, the pH-buffering system can maintain the beverage pH at a value that departs from the isoelectric point of the relevant protein by at least about 0.5 pH units, or by at least about 1.0 pH unit. For dairy-based whitening agents, the target beverage pH can be maintained within about 3.0 to about 4.0, positioning the pH sufficiently below the casein isoelectric point to maintain a net positive surface charge on the protein particles and sustain electrostatic repulsion sufficient to prevent aggregation. Where the target beverage pH falls within about 5.0 to about 5.5, the pH is maintained sufficiently above the casein isoelectric point to sustain a net negative surface charge on the protein particles. The selection between these sub-ranges can depend on desired flavor profile, achievable buffering capacity with food-grade acid-salt pairs at the respective pH levels, and compatibility of other beverage components with the target pH. For plant-based whitening agents, the pH-buffering system can be similarly calibrated relative to the isoelectric point of the specific plant protein present, with a minimum departure of about 0.5 pH units maintained throughout the designated shelf life.

The method of manufacturing 30 can further comprise a two-stage emulsification protocol within the emulsification process 38. A first emulsification stage can combine the whitening agent 18 with the stabilizer 42 components at a high-shear mixing tip speed of between about 10 m/s and about 40 m/s for a residence time of about 30 seconds to about 5 minutes to produce a coarse pre-emulsion having a mean fat globule diameter of about 2 micrometers to about 10 micrometers. A second emulsification stage can pass the coarse pre-emulsion through a high-pressure homogenizer operating at a first-stage pressure of about 1,500 psi to about 2,500 psi and a second-stage pressure of about 300 psi to about 700 psi to reduce mean fat globule diameter to below about 1 micrometer. The flavoring syrup 16 can be incorporated into the coarse pre-emulsion during the first emulsification stage so that flavor compounds are uniformly distributed throughout the emulsion prior to high-pressure homogenization. The homogenization step can further reduce flavor oil droplet diameter and embed flavor compounds within the interfacial film of the emulsifier at the fat globule surface, producing enhanced flavor retention and a more consistent flavor release profile upon consumption.

Following the two-stage emulsification protocol, the droplet size distribution of the resulting flavored whitening mixture can be verified by inline laser diffraction particle size analysis before the flavored whitening mixture advances to the blending step 40. Any batch exhibiting a volume-weighted mean diameter D(4,3) exceeding about 1.5 micrometers can be automatically recycled through the second emulsification stage for re-processing. This closed-loop quality gate can confirm emulsion specification compliance prior to incorporation into the final beverage composition 32 and can prevent under-emulsified product from entering sealed containers 22 during the filling and sealing step 44.

In closing, it is to be understood that although aspects of the present specification are highlighted by referring to specific embodiments, one skilled in the art will readily appreciate that these disclosed embodiments are only illustrative of the principles of the subject matter disclosed herein. Therefore, it should be understood that the disclosed subject matter is in no way limited to a particular methodology, protocol, and/or reagent, etc., described herein. As such, various modifications or changes to or alternative configurations of the disclosed subject matter can be made in accordance with the teachings herein without departing from the spirit of the present specification. Lastly, the terminology used herein is for the purpose of describing particular embodiments only and is not intended to limit the scope of the present disclosure, which is defined solely by the claims. Accordingly, embodiments of the present disclosure are not limited to those precisely as shown and described.

Certain embodiments are described herein, including the best mode known to the inventors for carrying out the methods and devices described herein. Of course, variations on these described embodiments will become apparent to those of ordinary skill in the art upon reading the foregoing description. Accordingly, this disclosure includes all modifications and equivalents of the subject matter recited in the claims appended hereto as permitted by applicable law. The terms “including” and “such as” are not limiting and should be interpreted as “including, but not limited to,” and “such as, for example,” respectively. Moreover, any combination of the above-described embodiments in all possible variations thereof is encompassed by the disclosure unless otherwise indicated herein or otherwise clearly contradicted by context.

I claim:

1. A shelf-stable beverage composition comprising:
a base liquid selected from the group consisting of at least one of a carbonated beverage, a non-carbonated beverage, and a nitro-infused beverage;
at least one flavoring syrup;
a whitening agent;
a stabilizer comprising at least one emulsifier; and
a sealed container.

2. The beverage composition of claim 1, wherein the whitening agent is selected from the group consisting of at least one of dairy-based cream, milk, sweet cream, coconut cream, oat milk, almond milk, plant-based emulsions, and synthetic whitening agents.

3. The beverage composition of claim 1, wherein the flavoring syrup is selected from the group consisting of at least one of coconut, vanilla, cherry, caramel, peach, mango, and combinations thereof.
The beverage composition of claim 1, wherein the stabilizer comprises at least one emulsifier selected from the group consisting of at least one of sunflower lecithin, xanthan gum, and polysorbate 80.

5. The beverage composition of claim 1, wherein the sealed container is a pressurized container selected from an aluminum can or a PET bottle.

6. The beverage composition of claim 1, wherein the base liquid is a nitro-infused beverage comprising nitrogen gas.

7. The beverage composition of claim 6, wherein the nitro-infused beverage further comprises carbon dioxide gas in combination with the nitrogen gas.

8. The beverage composition of claim 1, wherein the whitening agent remains suspended in the carbonated base liquid without excessive foaming.

9. The beverage composition of claim 8, wherein the absence of excessive foaming is determined by a standardized test method comprising dispensing the beverage composition conditioned to a temperature of about 4°C to about 8°C into a transparent cylindrical vessel having a total capacity of about 250 mL at a controlled pour rate of approximately 80-120 mL per second from a dispensing height of approximately 2-5 cm, wherein the beverage composition exhibits a foam volume fraction of no greater than about 25% of total dispensed volume within 10 seconds after dispensing and an initial foam height of no greater than about 3 cm as measured within approximately 1-3 seconds after dispensing.

10. A method of manufacturing a shelf-stable beverage composition, comprising:
preparing a base liquid selected from the group consisting of at least one of a carbonated beverage, a non-carbonated beverage, and a nitro-infused beverage;
combining at least one flavoring syrup with a whitening agent using an emulsification process to form a flavored whitening mixture;
mixing the flavored whitening mixture with the base liquid in a controlled environment at a chilled temperature;
adding a stabilizer comprising at least one emulsifier;
filling the beverage composition into a container; and
sealing the container wherein the beverage composition maintains a visually marbled appearance without complete separation for at least 6 months.

11. The method of claim 10, wherein the whitening agent is selected from the group consisting of at least one dairy-based cream, milk, sweet cream, coconut cream, oat milk, almond milk, plant-based emulsions, and synthetic whitening agents.

12. The method of claim 10, wherein the flavoring syrup is selected from the group consisting of at one of coconut, vanilla, cherry, caramel, peach, mango, and combinations thereof.

13. The method of claim 10, wherein the stabilizer comprises at least one emulsifier selected from the group consisting of at least one of sunflower lecithin, xanthan gum, and polysorbate 80.

14. The method of claim 10, wherein the container is a pressurized container selected from the group consisting of an aluminum can or a PET bottle.

15. The method of claim 10, wherein preparing the base liquid comprises infusing the base liquid with nitrogen gas.

16. The method of claim 15, wherein preparing the base liquid further comprises infusing the base liquid with a combination of nitrogen gas and carbon dioxide gas.

17. The method of claim 10, further comprising conducting stability testing to ensure preservation of gas infusion and beverage integrity over a shelf life of 6 to 12 months.

18. A system for producing a shelf-stable dirty beverage, comprising:
a mixer configured to combine a whitening agent with at least one flavoring syrup;
an emulsifier configured to create a stable emulsion of the whitening agent and the flavoring syrup;
a gas infuser configured to infuse a base liquid with at least one gas selected from carbon dioxide and nitrogen;
a temperature-controlled blending chamber configured to combine the stable emulsion with the gas-infused base liquid; and
a filling station configured to package the combined mixture into sealed containers.

19. The system of claim 18, wherein the gas infusion mechanism is configured to infuse the base liquid with a combination of carbon dioxide and nitrogen in variable ratios.

20. The system of claim 18, wherein the temperature-controlled blending chamber maintains the mixture at a temperature between 33 °F and 45 °F during blending to preserve gas infusion and emulsion stability.
